(19) United States
(12) Patent Application Publication
(10) Pub. No.: US 2014/0195265 A1
(43) Pub. Date: Jul. 10, 2014

(54) METHOD FOR REIMBURSEMENT OF HEALTHCARE SERVICES

(71) Applicants: Rhonda K. Kings, Rancho Santa Margarita, CA (US); Kevin M. Nelson, Sherman Oaks, CA (US)

(72) Inventors: Rhonda K. Kings, Rancho Santa Margarita, CA (US); Kevin M. Nelson, Sherman Oaks, CA (US)

(73) Assignee: ALLERGAN, INC., Irvine, CA (US)

(21) Appl. No.: 14/236,240

(22) PCT Filed: Aug. 1, 2012
(86) PCT No.: PCT/US2012/049113

§ 371 Date: Jan. 30, 2014

Related U.S. Application Data
(60) Provisional application No. 61/513,861, filed on Aug. 1, 2011.

(51) Int. Cl. G06Q 50/22

(52) U.S. Cl. CPC G06Q 50/22
USPC 705/2

(57) ABSTRACT

Embodiments of the invention relate to methods for gaining reimbursement for provided healthcare services.

### CROSS REFERENCE TO RELATED APPLICATION

This patent application claims priority pursuant to 35 U.S.C. §119(e) to U.S. Provisional Patent Application Ser. No. 61/513,861 filed Aug. 1, 2011, which is hereby incorporated by reference in its entirety.

### FIELD OF THE INVENTION

The present invention relates to methods for improving healthcare reimbursement procedures.

### BACKGROUND

Reimbursement refers to compensation or repayment for healthcare services. Accurate reimbursement requires accurate claims submission and compliance with reimbursement regulations and policies. This process is unique to the healthcare industry for several reasons. First, the vast majority of payment is not actually paid by the patient, but rather by a third party on behalf of the patient. Second, the level of payment for a set of identical services may vary dramatically based upon the actual third party payer. Third, the actual determination of payment for a specific third party payer is often complex, based upon preestablished or negotiated rules of payment that are frequently related to the codes entered upon a patient's bill or claim. Fourth, the government is often the largest single payer and does not negotiate payment but simply defines the rules for payment upon which it will render compensation for services provided to its beneficiaries.

To gain some perspective of the complexity of reimbursement in the healthcare industry, consider a typical managed care contract with a hospital. Assume this payer pays for inpatient services on a per-diem basis, with separate rates for medical and surgical cases. Finally, obstetrics and nursery care services are paid on case rates. Outpatient services are paid on a mix of fee schedules and discounted billed charges. Outpatient surgical cases are paid on a fee schedule based upon designated ambulatory surgical groups. Emergency visits are also on a fee schedule, based upon level of service. Other fee schedules exist for specific imaging procedures.

In the United States, healthcare services are often provided before payment is made. As a result, physicians, clinics, hospitals, and other healthcare provider organizations (“providers”) request reimbursement for health services provided in addition to expenses incurred. Currently, reimbursement of claims for healthcare services depends on the assignment of medical codes to describe diagnoses, services, and procedures provided. Various healthcare reimbursement methodologies exist. In a prospective payment system (PPS) for example, payment rates for healthcare services are established in advance for a specific time period. The predetermined rates are based on average levels of resource use for certain types of healthcare. In contrast, the retrospective payment method is a type of fee-for-service (FFS) reimbursement where providers receive payment, after health services have been rendered, based on either billed charges for services provided or on annually updated fee schedules. Capitation is a method of reimbursement for health services in which an individual or institutional provider is paid a fixed, per capita amount for each person enrolled, without regard to the actual number of services provided or actual costs incurred.

The Health Insurance Portability and Accountability Act of 1996 (HIPAA) adopted certain standard transactions for electronic data interchange (EDI) for the transmission of healthcare data. Transactions are electronics exchanges involving the transfer of healthcare information between two parties for specific purposes, such as a healthcare provider submitting medical claims to a health plan for payment. These transactions include:

Claims and encounter information

Payment and remittance advice

Claims status, eligibility, enrollment, and disenrollment

Referrals and authorizations

Premium payment

The acronym HCPCS originally stood for HCFA Common Procedure Coding System, as the Centers for Medicare and Medicaid (CMS) was previously (before 2001) known as the Health Care Financing Administration (HCFA). The Healthcare Common Procedure Coding System (HCPCS) was established in 1978 to provide a standardized coding system for describing the specific items and services provided in the delivery of health care. Such coding is necessary for Medicare, Medicaid, and other health insurance programs to ensure that insurance claims are processed in an orderly and consistent manner. Initially, use of the codes was voluntary, but with the implementation of the HIPAA use of the HCPCS for transactions involving health care information became mandatory.

HCPCS includes three levels of codes:

Level I consists of the American Medical Association's Current Procedural Terminology (CPT) and is numeric.

Level II codes are alphanumeric and primarily include non-physician services such as ambulance services and prosthetic devices, and represent items and supplies and non-physician services not covered by CPT-4 codes (Level I).

Level III codes, also called local codes, were developed by state Medicaid agencies, Medicare contractors, and private insurers for use in specific programs and jurisdictions. The use of Level III codes was discontinued on Dec. 31, 2003, in order to adhere to consistent coding standards.

Due to the complexity of the healthcare reimbursement system, pharmaceutical suppliers often provide reimbursement assistant services for the drugs they ship to health care providers. These services can include insurance and benefits verification, prior authorization assistance, recertification, claims appeals and general reimbursement counseling and patient assistance programs. Frequently, these services are provided by a call center. However, faced with a health care reimbursement system of increasing complexity, these call center-based systems are increasingly unable to provide sufficient support to providers. For example, suppliers currently face the issue that limited call center bandwidth negatively impacts their ability to assist with tasks such as claims submissions, processing, insurance verification, claim status and other areas, leaving their customers, the providers, to face the challenge of cost recovery without adequate assistance. These challenges inherent to the reimbursement process are where many of today's current inefficiencies reside. For example,

Providers face long lead times due to the complexity of various submission processes and requirements by different payers;

Few providers can deploy the resources necessary to support the administration of this back and forth exchange of multiple paper forms required between multiple actors (with potential multiple occasions for typing, spelling, and data entry errors);

For suppliers and providers, it is difficult to consolidate information residing in different silos/systems;

Long cycle times between provider and payer for reimbursement of drugs and medical services impact access metrics and hamper providers' enthusiasm of using the suppliers' products, ultimately negatively influencing sales and revenue.

Therefore, improved methods of provider reimbursement are needed.

### DESCRIPTION OF EXEMPLARY EMBODIMENTS

Embodiments of the invention can provide a 24 hour-a-day resource for providers to interact with payers to assist with, for example, billing reimbursement. In certain embodiments, the resource can relate to, for example, the products of a specific manufacturer, or the like.

Embodiments of the invention can comprise an automated on-line web portal including means for healthcare providers to interact with information sources, such as, for example, a database. The database can provide, for example, the ability to upload or enter data, the ability to upload or enter queries, the ability to respond to queries, the ability to download data, and the like. Embodiments of the invention provide benefits to providers by expediting the reimbursement process and also allow pharmaceutical suppliers to gain insights from the aggregate data accumulated (de-identified), which can add value to reimbursement strategies and decision making Further, embodiments of the invention allow providers to gain the benefit of the suppliers' experience in determining the appropriate billing codes for their own products and services. In certain embodiments, the web portal can generate and send an electronic communication to a provider reminding them of a patient's, for example, claim status, eligibility for services, need for follow up, and the like.

Embodiments of the invention can comprise a database providing information related to the reimbursement process, such as, for example, billing codes, and the like. Embodiments of the invention can comprise a real-time voice or data link between health care reimbursement professionals, such as, for example, doctors, nurses, billing experts, insurance experts, and the like.

### DEFINITIONS

HIPAA—Health Insurance Portability and Accountability Act: enacted by Congress in 1996, HIPAA protects health insurance coverage for workers and their families when they change or lose their jobs and required the establishment of national standards for electronic health care transactions and national identifiers for providers, health insurance plans, and employers. These standards establish rigorous guidelines upon which reimbursement depends. Included in Title II of HIPAA is the Privacy Rule, which establishes regulations for the use and disclosure of Protected Health Information (PHI).

PHI—Protected Health Information: information about health status, provision of health care, or payment for health care that can be linked to an individual. This data can be gathered and used to better-profile and serve the end users of pharmaceuticals.

Providers—any member of a professional healthcare provider organization (e.g., medical practice personnel, hospital personnel, etc.) that is responsible for submitting claims for the reimbursement of costs associated with providing pharmaceuticals to patients. This includes, but is not limited to, physicians and practice managers.

PRS—Provider Reimbursement Solution: portal solution for use by providers to provide support for reimbursement services.

Embodiments of the invention provide eligibility and benefit verification services through support of HIPAA-compliant Health Care Eligibility and Benefit Inquiry and Response (270/271) transactions through a clearinghouse for providers when related to patients receiving services. For example, in an embodiment, a healthcare provider can query the on-line database to confirm a patient's eligibility for healthcare coverage.

In certain embodiments, online eligibility (270) transactions for all active patients can be sent to determine if their insurance has changed as compared to the prior year.

In certain embodiments, prior authorization transaction can be initiated automatically and sent electronically.

Certain embodiments of the invention can provide claim status through support of HIPAA compliant Health Care Claim Status Inquiry and Response (276/277) transactions through a clearinghouse for providers when related to claims for patients receiving services. For example, by supplying patient information including name, provider, insurance company, and date of service, a provider can access a claim status response indicating whether a claim was, for example, paid, denied, still pending, etc.

Certain embodiments of the invention can obtain information from providers utilizing the embodiment. This information can be used to create HIPAA compliant 270 and 276 transactions. In some embodiments the transactions can be sent to a clearinghouse for processing through to the appropriate payers. Responses from the payers can be returned to embodiments of the invention as HIPAA 271 and 277 transactions, which can be made available to the provider.

Embodiments of the invention can interface with a designated clearinghouse partner to receive and transmit EDI (Electronic Data Interchange) transaction messages. The clearinghouse can register interested providers with all appropriate health plans for eligibility and claim status transaction support, without invalidating any other existing connectivity from the provider to the health plan(s).

The clearinghouse can receive HIPAA compliant eligibility and Benefit Request (270) and Claim Status Request (276) transactions from embodiments of the invention in the name of the provider. The clearinghouse will route HIPAA compliant Eligibility and Benefit Request (270) and Claim Status Request (276) transactions from an embodiment of the invention to the appropriate Health Plan(s). The clearinghouse will receive HIPAA compliant Eligibility and Benefit Response (271) and Claim Status Response (277) transactions from Health Plans(s). The clearinghouse will route HIPAA compliant Eligibility and Benefit Response (271) and Claim Status Response (277) transactions received from Health Plans(s) in response to requests from embodiments of the invention for delivery to the provider.

Embodiments of the invention can assess provider inputted data to simulate a claim presented to a payer. This simulation will provide guidance to the provider on accuracy of treatments based on diagnosis per that insurance company's healthplan policy.

Embodiments of the invention can allow a provider to opt in to an Automated Benefit Check, which automatically sends Eligibility and Benefit Request (270) after a designated period of time to provide a pro-active patient eligibility service to providers.

In certain embodiments, no charges for these transactions/services are passed to the provider by the clearinghouse.

### EXAMPLE

The following example illustrates an embodiment of the present invention and is not intended to limit the scope of the present invention.

### Example 1

Method for Performing Automated Healthcare Benefit Eligibility Verification

A patient receives healthcare services for pain associated with arthritis. The provider initiates the reimbursement process by logging into an embodiment of the invention comprising a website and associated database. The provider uploads the patient's information including age, sex, height, weight, medical history, diagnosis, insurance company, health plan, and course of treatment provided. The uploaded information is stored and the course of treatment is analyzed and compared to the patient's health benefit plan to confirm her eligibility for benefits. Once confirmed, her course of treatment is formatted into valid EDI format HIPAA-compliant Health Care Eligibility and Benefit Inquiry and Response (270/271) transactions. Next, these transactions are forwarded to the healthcare provider.

What is claimed is:

1. A method of reimbursing healthcare providers, comprising;
accepting input data from providers; and
reformatting the data into HIPAA-compliant Health Care Eligibility and Benefit Inquiry and Response (270/271) transactions; and
Providing the transaction outcomes to healthcare providers.
